(19) United States
(12) Patent Application Publication
(10) Pub. No.: US 2015/0373821 A1
(43) Pub. Date: Dec. 24, 2015

(54) RADIATION GENERATING APPARATUS AND RADIATION IMAGING SYSTEM

(71) Applicant: CANON KABUSHIKI KAISHA, Ohta-ku, Tokyo (JP)

(72) Inventors: Yoshio Suzuki, Kawasaki-shi (JP); Koji Yamazaki, Ayase-shi (JP)

(21) Appl. No.: 14/764,337

(22) PCT Filed: Jan. 8, 2014
(86) PCT No.: PCT/JP2014/000045

§ 371 Date: Jul. 29, 2015

(30) Foreign Application Priority Data
Jan. 31, 2013 (JP) 2013-016599

(51) Int. Cl. H05G 1/02; G01N 23/04; H05G 1/04

(52) U.S. Cl. CPC H05G 1/025; H05G 1/04; G01N 23/04

(57) ABSTRACT

A radiation generating apparatus includes a radiation tube including an electrically insulating tubular member, a cathode provided at one of two openings of the tubular member, and an anode provided at the other opening of the tubular member; an electrically insulating outer tube surrounding at least a peripheral side of the radiation tube with a separation interposed therebetween; and a container that contains the radiation tube and the outer tube. A space in the container is filled with an insulating liquid. At least a portion of a gap between the tubular member and the outer tube is wider than at least one of a gap between the cathode and the outer tube and a gap between the anode and the outer tube.

### TECHNICAL FIELD

The present invention relates to a radiation generating apparatus that is applicable to radiation imaging in the fields of medical apparatuses and industrial apparatuses, and also relates to a radiation imaging system including the same.

### BACKGROUND ART

In a typical radiation generating apparatus, a high voltage is applied between a cathode and an anode that are provided in a radiation tube, and electrons emitted from the cathode are applied to the anode, whereby radiation is generated. To provide a satisfactory resistance to the high voltage and to cool the radiation tube, the radiation tube included in such a radiation generating apparatus is provided in a container that is filled with an insulating liquid.

Most of energy generated by the electrons applied to the anode is converted into heat. The heat generated by the anode is sequentially transmitted to the wall of the radiation tube, to the insulating liquid, and to the container, and is released into the atmosphere on the outside of the container. To fully cool an area around the anode and to release the heat generated by the anode to the outside via the container, it is important that the heat in a high-temperature area is effectively transported to a low-temperature area by causing the insulating liquid, which functions as a coolant, to flow through a wide area.

A high voltage is applied to the two electrodes of the radiation tube. Therefore, even if the container is filled with the insulating liquid, a member that insulates peripheral members from the high voltage may be additionally provided. PTL 1 discloses an X-ray generating apparatus including an insulating sleeve (outer tube) made of a dielectric material and provided on the outer side of an X-ray tube, with a gap between the insulating sleeve and the X-ray tube being filled with an insulating oil.

### CITATION LIST

### Patent Literature

PTL 1: Japanese Patent Laid-Open No. 2007-80568

### SUMMARY OF INVENTION

### Technical Problem

FIG. 6 schematically illustrates a configuration of a radiation generating apparatus including a transmission radiation tube 2 and an outer tube 5 provided on the outer side of the radiation tube 2. A gap 6 is provided between the outer surface of the radiation tube 2 and the inner surface of the outer tube 5. The gap 6 is filled with an insulating liquid 4. In general, it is effective to cool a heat generating body by causing an insulating liquid to flow therearound. However, if friction occurs between an insulating solid and an insulating liquid flowing therealong, electric discharge due to the flow may occur. In such a case, electrostatic charges may accumulate on the surface of the insulating solid. The radiation tube 2 includes an electron source provided in a vacuum container. The vacuum container includes an insulating tubular member 32 having openings at two respective ends thereof, with a cathode 31 and an anode 33 provided at the respective ends of the tubular member 32. Hence, the surface of the tubular member 32 is electrostatically charged by the flow of the insulating liquid 4, that is, electrostatic charges accumulate on the surface of the tubular member 32. Consequently, microdischarge may occur around the radiation tube 2, leading to the generation of electromagnetic noise. Moreover, if such microdischarge occurs repeatedly, the insulating liquid 4 may be deteriorated with time and may form a tracking path leading to the surface of the tubular member 32.

Although the presence of the outer tube 5 prevents the increase in the damage to peripheral members caused by such discharge, it is difficult to reduce the rate of incidence of creeping microdischarge that may occur between the cathode 31 and the anode 33 to which a high voltage is applied. Hence, if such creeping microdischarge occurs repeatedly, electric discharge decomposition of the insulating liquid 4 may advance, accelerating the deterioration of the insulating liquid 4. Moreover, such creeping microdischarge may form a tracking path leading to the tubular member 32 of the radiation tube 2, accelerating the long-term deterioration of the voltage resistance of the radiation generating apparatus as a whole.

That is, there is a contradiction between an effect of cooling the radiation tube with the flow of the insulating liquid and an effect of suppressing the creeping discharge on the radiation tube.

In light of the above, the present invention provides a radiation generating apparatus including a radiation tube provided in a container filled with an insulating liquid and an outer tube provided for improving the voltage resistance of the radiation generating apparatus, in which effective cooling of a high-temperature area including an anode and peripheral members and suppression of creeping discharge are both realized.

### Solution to Problem

A radiation generating apparatus includes a radiation tube including an electrically insulating tubular member, a cathode provided at one of two openings of the tubular member, and an anode provided at the other opening of the tubular member; an electrically insulating outer tube surrounding at least a peripheral side of the radiation tube with a separation interposed therebetween; and a container that contains the radiation tube and the outer tube. A space in the container is filled with an insulating liquid. At least a portion of a gap between the tubular member and the outer tube is wider than at least one of a gap between the cathode and the outer tube and a gap between the anode and the outer tube.

Further features of the present invention will become apparent from the following description of exemplary embodiments with reference to the attached drawings.

### BRIEF DESCRIPTION OF DRAWINGS

FIG. 1 is a schematic sectional view of a radiation generating apparatus according to an embodiment of the present invention.

FIG. 2 is a schematic sectional view illustrating an internal configuration of a radiation tube according to the embodiment of the present invention.

FIG. 3 is a schematic sectional view of a radiation tube and an outer tube included in a radiation generating apparatus according to another embodiment of the present invention.

FIG. 4 is a block diagram of a radiation imaging system according to yet another embodiment of the present invention.

FIG. 5 is a schematic sectional view of a radiation tube and an outer tube according to Example 1.

FIG. 6 is a schematic sectional view of a radiation generating apparatus according to a related art including a radiation tube and an outer tube provided on the outer side of the radiation tube.

### DESCRIPTION OF EMBODIMENTS

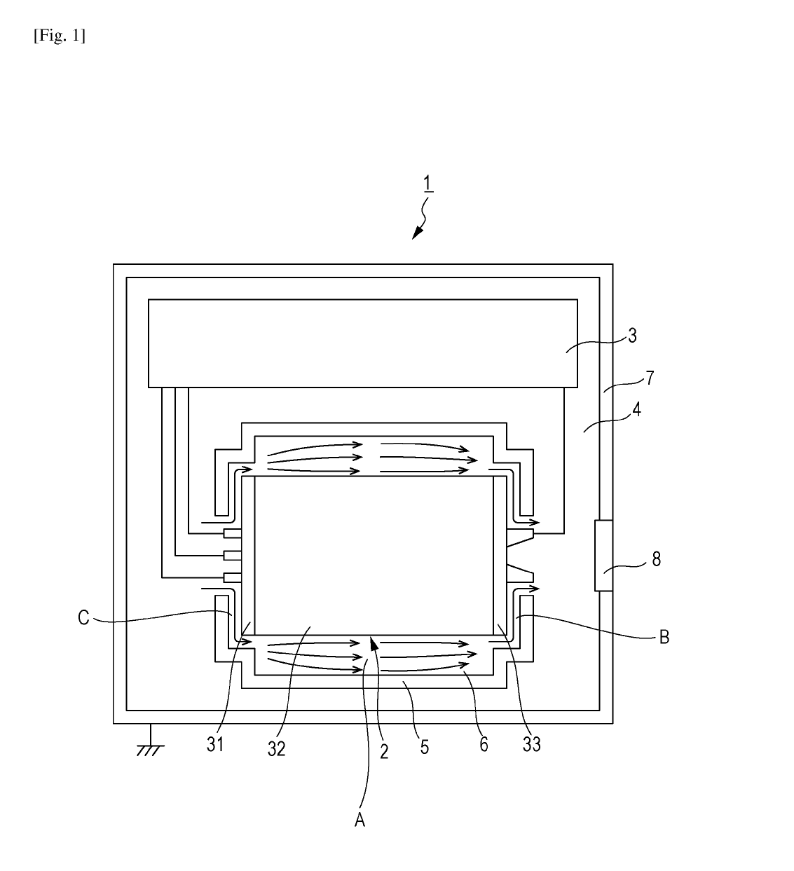

Referring to FIG. 1, a radiation generating apparatus 1 according to a first embodiment of the present invention will now be described. The radiation generating apparatus 1 includes a radiation tube 2 and a driving circuit 3 that are provided in a container 7. A space in the container 7 is filled with an insulating liquid 4. A high voltage of 40 kV to 150 kV generated by the driving circuit 3 is applied between a cathode 31 and an anode 33 of the radiation tube 2.

The insulating liquid 4 functions as an insulator that provides the radiation tube 2 with a satisfactory creepage-surface voltage resistance and also functions as a coolant that cools the radiation tube 2 that generates heat when radiation is generated. The insulating liquid 4 may be an electrically insulating oil such as mineral oil, silicone oil, or the like. Other available examples of the insulating liquid 4 include fluorine-based electrically insulating liquid.

To effectively release the heat generated by the anode 33 to the outside via the container 7, it is important to cause the insulating liquid 4 to flow through a wide area and to quickly transport the heat from a high-temperature area to a low temperature area. When a high voltage is applied to the radiation tube 2, the insulating liquid 4 undergoes convection by an electrohydrodynamic (EHD) effect. That is, the insulating liquid 4 can be made to flow by utilizing such an EHD effect.

The container 7 may have a ground potential by being grounded via a grounding terminal, considering the stability and safety in the operation of the radiation generating apparatus 1. The container 7 may be made of metal such as iron, stainless steel, lead, brass, copper, or the like, considering the radiation-blocking characteristic, strength, and the surface-potential-defining characteristic. If the container 7 has a ground potential, a voltage of +Va may be applied between the cathode 31 and the anode 33 with the potential of the cathode 31 defined as −Va/2 and the potential of the anode 33 defined as +Va/2, considering the stability of voltage resistance on the inside of the radiation generating apparatus 1. The container 7 has a radiation emitting window 8 provided at a position corresponding to the focal point of radiation 27 (see FIG. 2).

The peripheral side of the radiation tube 2 is enclosed by an outer tube 5. The outer tube 5 prevents the driving circuit 3 from being damaged by an increase in microdischarge that may occur on the creepage surface of the radiation tube 2. A gap 6 is provided between the outer tube 5 and the radiation tube 2. The insulating liquid 4 flows through the gap 6, functioning as a passage, as illustrated by the arrows in FIG. 1.

In general, the degree of static electricity on an insulating surface with the flow of the insulating liquid 4 depends on the flow speed of the insulating liquid 4. As illustrated in FIG. 2, the radiation tube 2 includes a vacuum container 34. The vacuum container 34 includes an insulating tubular member 32, a cathode 31 provided over an opening at one end of the tubular member 32, and an anode 33 provided over an opening at the other end of the tubular member 32. Hence, to reduce the amount of static electricity generated on the surface of the insulating tubular member 32, it is effective to reduce the flow speed of the insulating liquid 4. On the other hand, the flow of the insulating liquid 4 is responsible for cooling the radiation tube 2. Hence, a certain amount of flow needs to be made.

Therefore, among different portions of the gap between the radiation tube 2 and the outer tube 5, a central portion (gap A) between the tubular member 32 and the outer tube 5 is wider than a portion (gap C) between the cathode 31 and the outer tube 5 and/or a portion (gap B) between the anode 33 and the outer tube 5. Thus, the flow speed of the insulating liquid 4 in the gap A is made lower than the flow speed of the insulating liquid 4 in the gap B and/or the gap C. The gap 6 may be widened at least in a portion thereof between the tubular member 32 and the outer tube 5. For example, as illustrated in FIG. 1, the gap 6 may be widened over the entirety of a portion thereof where the tubular member 32 and the outer tube 5 face each other. In addition, the gap A may be wider than the gap B and the gap C. Particularly, since the anode 33 tends to have a high temperature, the gap A may be wider than the gap C, and the gap C may be wider than the gap B. More specifically, the gap A may be 2.0 to 10.0 times wider than at least one of the gap B and the gap C for the following reasons. The gap B and the gap C are each preferably 1 mm to 5 mm, considering the cooling effect. The gap A is preferably 2 mm to 50 mm, considering the effect of suppressing charging and a reduction in the size of the radiation generating apparatus.

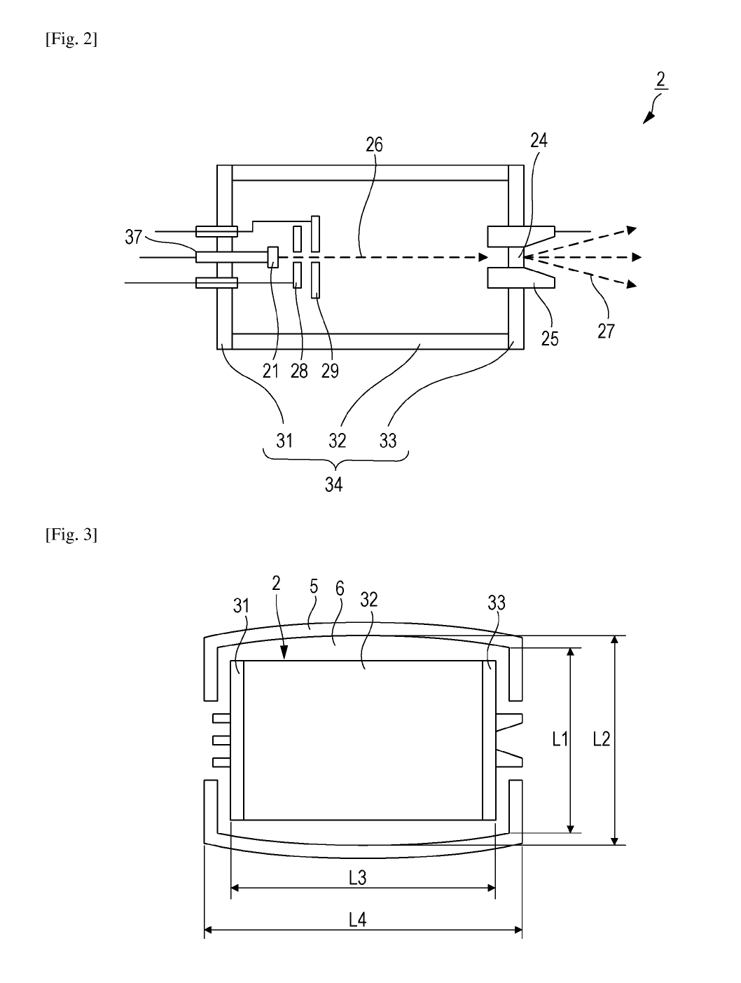

The gap A may be constant as illustrated in FIG. 1, or may be gradually widened from each end of the tubular member 32 toward a central part of the tubular member 32 as illustrated in FIG. 3.

The insulating liquid 4 may be made to flow by a liquid delivering device (not illustrated). On a condition where a high voltage of about 40 kV to 150 kV is applied between the cathode 31 and the anode 33, the insulating liquid 4 may alternatively be made to flow spontaneously by utilizing an EHD effect.

Since the insulating liquid 4 is made to flow through the gap 6 between the outer tube 5 and the radiation tube 2 as described above, the heat generated from the radiation tube 2 is efficiently released to the outside, allowing the radiation generating apparatus 1 to continuously operate with a high power. Moreover, with the gap 6 that is widened partially, the amount of charging on the surface of the tubular member 32 is reduced, and the rate of incidence of creeping microdischarge is thus reduced.

In FIG. 1, the insulating liquid 4 flows from the side of the cathode 31 toward the side of the anode 33. The direction of the flow of the insulating liquid 4 is changeable depending on the position of the liquid delivering device (not illustrated) or other conditions.

Referring now to FIG. 2, an internal configuration of the radiation tube 2 will be described.

The radiation tube 2 is of a transmission type and includes an electron source 21, a transmissive target 24, a shielding member 25, and the vacuum container 34.

The vacuum container 34 includes the tubular member 32 that is electrically insulating, the cathode 31 provided over the opening at one of the two ends of the tubular member 32, and the anode 33 provided over the opening at the other end of the tubular member 32. The vacuum container 34 maintains the vacuum produced in the radiation tube 2. The degree of vacuum in the vacuum container 34 may be about 10⁻⁴ Pa to about 10⁻⁸ Pa.

The shielding member 25 defines the angle of radiation emitted to the outside and blocks the radiation from scattering into the vacuum container 34. The shielding member 25 is joined to the anode 33 of the vacuum container 34. The shielding member 25 has a passage that communicates with the outside of the vacuum container 34. The target 24 is fitted in the passage, whereby the vacuum container 34 is sealed.

The electron source 21 is provided opposite the target 24. An electron beam 26 emitted from the electron source 21 passes through the opening of the shielding member 25 and enters the target 24, whereby radiation 27 is generated. The shielding member 25 may be made of lead or tungsten. The electron source 21 is connected to the cathode 31 via a current introducing terminal 37.

A positive potential of 10 kV to 200 kV with respect to the electron source 21 (cathode 31) is applied to the target 24 (anode 33). The target 24 includes a supporting substrate made of diamond and a target film made of tungsten and provided on the supporting substrate.

The potentials of the cathode 31 and the anode 33 are defined by the driving circuit 3. The cathode 31 and the anode 33 define the electrostatic field produced in the radiation tube 2. Hence, the cathode 31 and the anode 33 may be arranged such that lines of electric force of the electrostatic field are as parallel as possible near each of the electron source 21 and the target 24. Therefore, the cathode 31 and the anode 33 may each define the potential in a space having a predetermined area. Furthermore, the cathode 31 and the anode 33 may each have a shape conforming to the cross section of a corresponding one of the openings of the insulating tubular member 32. In the configuration illustrated in FIG. 2, the potential of the target 24 is defined by the driving circuit 3 via the shielding member 25.

The materials of the cathode 31 and the anode 33 may be determined in accordance with conductivity, airtightness, strength, and the matching with the coefficient of linear expansion of the tubular member 32. For example, the cathode 31 and the anode 33 may be made of Kovar (a registered trademark), tungsten, or the like.

The tubular member 32 is electrically insulating and has at least two openings at which the cathode 31 and the anode 33 are provided respectively. The cross-sectional shape of the outer periphery or the inner periphery of the tubular member 32 is not limited to a circular shape and may be any polygonal shape. The tubular member 32 may be made of insulating ceramic such as boron nitride or alumina, or insulating inorganic glass such as borosilicate glass, considering the electrically insulating characteristic, airtightness, the low gas-emission characteristic, heat resistance, and the matching with the coefficients of linear expansion of the cathode 31 and the anode 33.

The cathode 31 and the anode 33 are each joined to the tubular member 32 with a joining member (not illustrated). The joining member may be hard solder (metal intended for soldering), such as silver solder or copper solder, having conductivity and heat resistance and providing a good characteristic of joining different materials of metal and an insulating material.

The radiation tube 2 may also be provided with an extraction electrode 28 and a lens electrode 29.

The outer tube 5 may be made of oil-resistant resin such as polyetherimide or acrylic resin.

In the first embodiment, the outer tube 5 is provided on the outer side of the radiation tube 2. Hence, to position the outer tube 5, the outer tube 5 may be secured to the radiation tube 2 with insulating screws or the like and may further be secured to the container 7 with insulating supporting members (not illustrated).

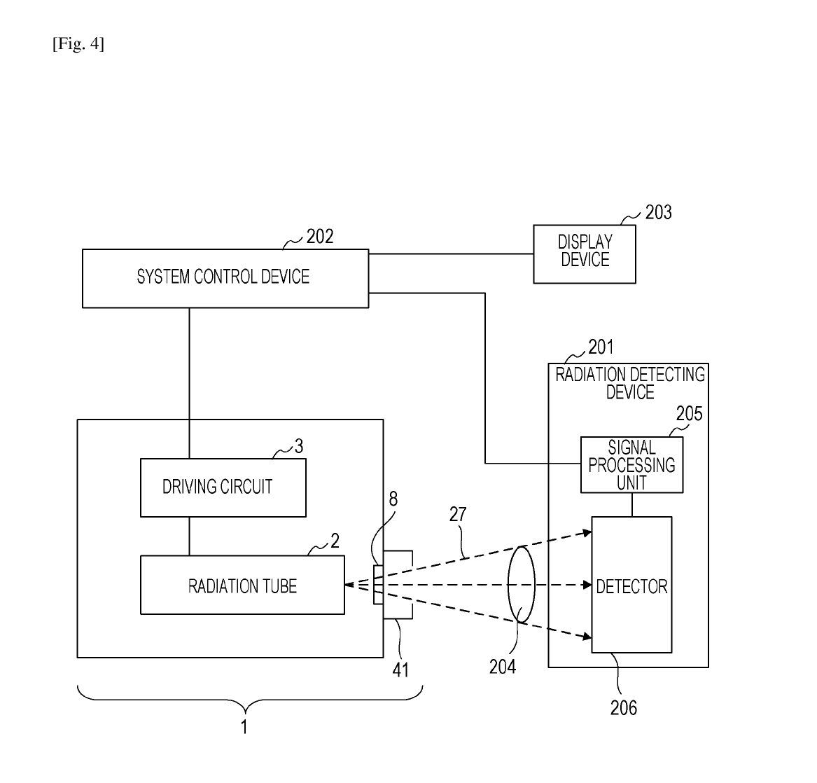

Referring now to FIG. 4, a radiation imaging system according to a second embodiment of the present invention will be described. In FIG. 4, as a matter of convenience, the outer tube 5 according to the first embodiment of the present invention is not illustrated.

The radiation generating apparatus 1 is provided with a movable diaphragm unit 41 at the radiation emitting window 8, according to need. The movable diaphragm unit 41 adjusts the size of a radiation field formed by the radiation 27 emitted from the radiation generating apparatus 1. The movable diaphragm unit 41 may have an additional function of simulating the radiation field by using a visible-light field.

A system control device 202 controls the radiation generating apparatus 1 in conjunction with a radiation detecting device 201. The driving circuit 3, which is also controlled by the system control device 202, outputs control signals to the radiation tube 2. In accordance with the control signals, the radiation 27 emitted from the radiation generating apparatus 1 is transmitted through an examination object 204 and is detected by a detector 206. The detector 206 converts the detected radiation 27 into an image signal and outputs the image signal to a signal processing unit 205. The signal processing unit 205, which is controlled by the system control device 202, processes the image signal as predetermined and outputs the processed image signal to the system control device 202. In accordance with the processed image signal, the system control device 202 outputs a display signal for displaying a corresponding image to a display device 203. The display device 203 displays an image that is based on the image signal as an image of the examination object 204 on a display.

A typical example of the radiation 27 is X-rays. An X-ray imaging system is applicable to nondestructive inspections of industrial products and pathological diagnoses of human bodies and animals.

### EXAMPLES

### Example 1

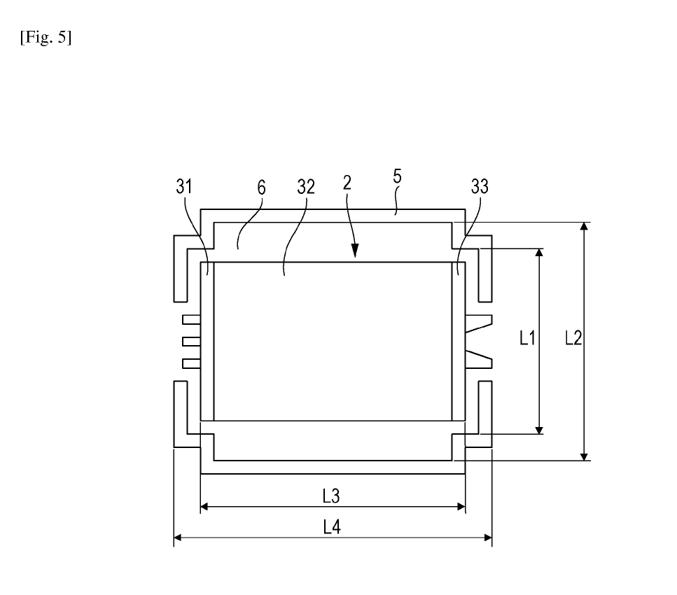

Referring to FIG. 5, a radiation tube 2 and an outer tube 5 according to Example 1 will now be described.

Major dimensions of the radiation tube 2 according to Example 1 were as follows: the outside diameter of the tubular member 32 was 50 mm, and a length (L3) of the radiation tube 2 inclusive of the cathode 31 and the anode 33 was 80 mm. The tubular member 32 was chiefly made of alumina ceramic. The cathode 31 was chiefly made of stainless steel. The anode 33 was chiefly made of stainless steel and copper.

Major dimensions of the outer tube 5 were as follows: a length (L4) was 100 mm, an inside diameter (L1) at each of portions thereof facing the cathode 31 and the anode 33, which were conductive members, was 60 mm, and an inside diameter (L2) at a portion thereof facing the tubular member 32 was 70 mm. The outer tube 5 was made of acrylic resin with a thickness of 5 mm.

In the above configuration, the gap 6 was provided between the outer tube 5 and the radiation tube 2 such that the gaps B and C were each 5 mm and the gap A was 10 mm, whereby the cross-sectional area of the passage for the insulating liquid 4 was expanded in an area along the surface of the tubular member 32. By employing such a configuration, the flow speed of the insulating liquid 4 flowing along the tubular member 32 was made lower than the flow speed of the insulating liquid 4 flowing along the cathode 31 and the anode 33. Consequently, the amount of charging on the surface of the tubular member 32 was reduced.

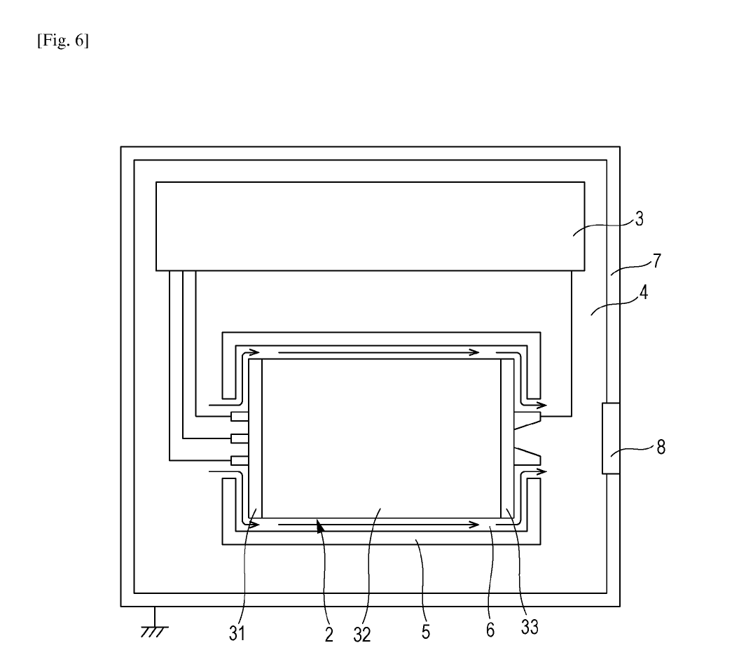

The radiation tube 2 and the outer tube 5 configured as described above were incorporated into the radiation generating apparatus 1 illustrated in FIG. 1, and a high voltage of 100 kV was applied between the cathode 31 and the anode 33. Then, the rate of incidence of creeping microdischarge was calculated. Furthermore, the outer tube 5 illustrated in FIG. 6 was prepared as Comparative Example. In FIG. 6, the inside diameter of the outer tube 5 was 60 mm at all of the portions facing the cathode 31, the anode 33, and the tubular member 32, that is, the gap 6 between the outer tube 5 and the radiation tube 2 was constant at 5 mm. As a result, in the radiation generating apparatus 1 according to Example 1, it was found that the rate of incidence of microdischarge was reduced to half to one third of that of the radiation generating apparatus according to Comparative Example.

Meanwhile, the amount of the insulating liquid 4 flowing along the surface of the radiation tube 2 was not reduced. Therefore, cooling efficiency was not reduced.

### Example 2

Another radiation generating apparatus 1 was prepared. The radiation generating apparatus 1 was the same as that of Example 1, except that the outer tube 5 illustrated in FIG. 3 was employed. Major dimensions of the radiation tube 2 were the same as those employed in Example 1. The outer tube 5 was fabricated such that the length (L4) was 100 mm, and the inside diameter was gradually increased from each of two ends thereof toward a central part thereof. Specifically, the inside diameter (L1) at the ends of the outer tube 5 facing the cathode 31 and the anode 33, respectively, was 60 mm, and the inside diameter (L2) at a portion of the outer tube 5 facing the central part of the tubular member 32 was 70 mm.

In the above configuration, the gap 6 was provided between the outer tube 5 and the radiation tube 2 such that the gaps B and C were each 5 mm and the gap at the central part of the tubular member 32 was 10 mm, whereby the cross-sectional area of the passage for the insulating liquid 4 was expanded in an area along the central part of the tubular member 32.

In Example 2 also, a high voltage of 100 kV was applied between the cathode 31 and the anode 33, and the rate of incidence of creeping microdischarge was compared with that of Comparative Example illustrated in FIG. 6. As a result, it was found that the rate of incidence of microdischarge was reduced to half to one third of that of the radiation generating apparatus according to Comparative Example. Furthermore, as in Example 1, cooling efficiency was not reduced.

According to the above embodiments of the present invention, since the peripheral side of the radiation tube is enclosed by the insulating outer tube, peripheral members including the driving circuit and so forth are prevented from being damaged with an increase in creeping discharge that may occur near the radiation tube. Particularly, in the embodiments of the present invention, the cross-sectional area of the passage for the insulating liquid provided between the radiation tube and the outer tube is expanded in an area surrounding the insulating tubular member. Hence, the flow speed of the insulating liquid flowing along the surface of the tubular member is reduced, whereby charging on the surface of the tubular member is reduced. Therefore, the rate of incidence of creeping discharge is reduced without lowering the effect of cooling the radiation tube. Consequently, voltage resistance is improved while the radiation tube is cooled efficiently. Thus, a radiation generating apparatus having a higher power and being capable of long, continuous emission of radiation is provided. Furthermore, since the creeping discharge from the radiation tube is suppressed and the rate of incidence of microdischarge is reduced, a radiation imaging system with a low rate of incidence of electromagnetic noise is provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-016599, filed Jan. 31, 2013, which is hereby incorporated by reference herein in its entirety.

### REFERENCE SIGNS LIST

1 radiation generating apparatus

2 radiation tube

4 insulating liquid

5 outer tube

6 gap

7 container

21 electron source

24 target

31 cathode

32 tubular member

33 anode

1. A radiation generating apparatus comprising:
a radiation tube including an electrically insulating tubular member, a cathode provided at one of two openings of the tubular member, and an anode provided at the other opening of the tubular member;
an electrically insulating outer tube surrounding at least a peripheral side of the radiation tube with a separation interposed therebetween; and
a container that contains the radiation tube and the outer tube,
wherein a space in the container is filled with an insulating liquid, and
wherein at least a portion of a gap between the tubular member and the outer tube is wider than at least one of a gap between the cathode and the outer tube and a gap between the anode and the outer tube.

2. The radiation generating apparatus according to claim 1, wherein the gap between the tubular member and the outer tube is constant.

3. The radiation generating apparatus according to claim 1, wherein the gap between the tubular member and the outer tube gradually increases from each end thereof toward a central portion thereof.

4. The radiation generating apparatus according to claim 1, wherein a central portion of the gap between the tubular member and the outer tube is 2.0 to 10.0 times wider than at least one of the gap between the cathode and the outer tube and the gap between the anode and the outer tube.

5. The radiation generating apparatus according to claim 1, wherein the radiation tube is of a transmission type.

6. A radiation imaging system comprising:
the radiation generating apparatus according to claim 1;
a radiation detecting device configured to detect radiation emitted from the radiation generating apparatus and transmitted through an examination object; and
a control device configured to control the radiation generating apparatus in conjunction with the radiation detecting device.
